(19) United States
(12) Patent Application Publication
(10) Pub. No.: US 2012/0104793 A1
(43) Pub. Date: May 3, 2012

(54) AUTOMOTIVE VEHICLE COMPOSITE BODY STRUCTURE

(75) Inventors: Kurt Henry Danielson, Carlsbad, CA (US); Lawrence Scott Thomas, Carlsbad, CA (US)

(73) Assignee: APTERA MOTORS, INC., Oceanside, CA (US)

(21) Appl. No.: 12/916,432

(22) Filed: Oct. 29, 2010

(51) Int. Cl. B62D 25/02; B23P 11/00; B62D 21/00; B62D 25/08; B62D 25/20

(52) U.S. Cl. 296/181.1; 296/191; 296/204; 29/428; 180/65.21

(57) ABSTRACT

An automotive vehicular structure includes a composite first body side outer panel including a first connecting panel and a composite second body side outer panel and a second connecting panel. The second connecting panel is directly attached to the first connecting panel at a location between the first side panel and the second side panel. A method of assembling an automotive vehicle is also provided.

### BACKGROUND AND SUMMARY

The present invention generally pertains to body structures for vehicles and, more particularly, to composite body structures for vehicles.

A vehicle is supported by a chassis that carries various loads. The loads include an unloaded weight of the vehicle and cargo loads generated by passengers and other items added to the vehicle. The loads also include aerodynamic loads and road loads input through a suspension as the vehicle is maneuvered over a road.

In some configurations, a body of the vehicle is part of the chassis. In such configurations, a structure of the body designed to carry the loads is typically composed of steel. Steel is most often employed because parts of the structure can be produced in high volume, at low cost, using conventional methods.

In accordance with the present invention, an all composite automotive vehicular structure and a method of assembling an automotive vehicle are provided. In one aspect, an automotive vehicular structure includes a composite first body side outer panel and composite second body side outer panel. The first body side outer panel includes a first side panel and a first connecting panel. The first side panel extends in a substantially longitudinal direction on a first side and defines at least an entire first door opening. The first connecting panel extends from the first side panel in a first substantially transverse direction. The second body side outer panel includes a second side panel and a second connecting panel. The second side panel extends in the substantially longitudinal direction on a second side opposite the first side and defines at least an entire second door opening. The second connecting panel extends from the second side panel in a second substantially transverse direction opposite the first transverse direction. The second connecting panel is directly attached to the first connecting panel at a location between the first side panel and the second side panel.

In another aspect, an automotive vehicular apparatus includes a composite floor pan, a composite structure joined to the floor pan, and a composite first outer panel joined to the floor pan and the structure. The composite floor pan includes a floor of a passenger compartment. The structure substantially surrounds at least a majority of an upper portion of the passenger compartment. The structure includes a roof member and elongated support members extending from the roof member to the floor pan. The first outer panel joined to the floor pan and the frame in a monocoque. The first outer panel is entirely composed of materials free of carbon fiber.

In another aspect, an automotive vehicular structure includes a composite first body side outer panel and a composite second body side outer panel. The first body side outer panel extends in a substantially longitudinal direction on a first side. The first body side outer panel defines at least an entire first body side opening. The first body side outer panel includes (i) a first roof panel part including a first tie rail extending in a first substantially transverse direction, (ii) a first rocker panel part, (iii) a first a-pillar part connecting the roof panel part and the rocker panel part, the a-pillar part including a second tie rail extending in the first substantially transverse direction, and (iv) a first quarter panel part connecting the roof panel part and the rocker panel part, the first quarter panel part including a third tie rail extending in the first substantially transverse direction. The composite second body side outer panel extends in the substantially longitudinal direction on a second side opposite the first side and defines at least an entire second body side opening. The second body side outer panel is directly attached to the first body side outer panel at a location between the first side and the second side. In a related aspect, the second body side outer panel includes: (a) a second roof panel part including a fourth tie rail directly attached to the first tie rail at a first location, (b) a second rocker panel part, (c) a second a-pillar part connecting the second roof panel part and the second rocker panel part, the second a-pillar part including a fifth tie rail directly attached to the second tie rail at a second location, and (d) a second quarter panel part connecting the second roof panel part and the second rocker panel part, the second quarter panel part including a sixth tie rail directly attached to the third tie rail at a third location.

In other aspects, an automotive vehicular structure includes a composite floor pan structure extending along a length between an a-pillar and a b-pillar, and a composite outer body structure coupled to the floor pan to create a first closed multi-sided rocker section along the length. In still other aspects, an automotive vehicular structure includes a composite underbody structure creating a first part of an a-pillar, and a composite outer body structure directly attached to the underbody structure to create a closed multi-sided a-pillar section along a length.

The present invention further provides a floor pan structure for an automotive vehicle. The floor pan structure includes a composite floor, a pair of sides integral to and extending from the floor as a single piece, and a raised section extending from the floor between the sides as a single piece, the raised section providing a mounting surface for a passenger seat.

In another aspect, an automotive vehicular structure includes a composite floor pan structure, a composite frame structure, and a composite outer body. The floor pan structure longitudinally extends along a length of a b-pillar and includes an integral outer side wall. The frame structure directly attaches to an outboard side of the outer side wall. The outer body structure directly attaches to the frame structure opposite the floor pan to create a closed multi-sided b-pillar section when viewed along the b-pillar.

In yet another aspect, an automotive vehicular structure includes a composite floor pan structure, a composite outer body structure, and a composite frame structure. The composite floor pan structure longitudinally extends along a length of a b-pillar and includes an integral outer side wall. The outer body structure is directly attached to a first side of outer side wall to create a first closed multi-sided b-pillar section when viewed along the b-pillar. The frame structure directly attaches to an opposite second side of the outer side wall to create a second closed multi-sided b-pillar section contiguous with the first closed b-pillar section.

The present automotive vehicular body structure is advantageous over other body structures. For example, the automotive vehicular structure provides an all composite monocoque structure that is of high strength and low weight. The automotive vehicular structure further provides structural sections and cross-sections, for example a-pillar, b-pillar, rocker, and floor pan sections and cross-sections. The various sections and cross-sections are created by composite panels and are advantageously resistive to impacts that occur, for example in a vehicle accident.

Additional advantages and features of the present invention will be found in the following description and accompanying claims, as well as in the appended drawings.

### DRAWINGS

FIG. 1 is a perspective view showing a vehicle according to the present disclosure;

FIG. 2 is a perspective view showing a composite body structure of the vehicle shown in FIG. 1;

FIG. 3 is a top view of the composite body structure shown in FIG. 2;

FIG. 4 is a bottom view of the composite body structure shown in FIG. 2;

FIG. 5 is an exploded perspective view of the composite body structure shown in FIG. 2;

FIG. 6 is an exploded perspective view of the composite body structure shown in FIG. 2;

FIG. 7 is an exploded perspective view of the composite body structure shown in FIG. 2;

FIG. 8 is a perspective view of an underbody sub-assembly illustrating the composite body structure shown in FIG. 2 in a partially assembled state;

FIG. 9 is a perspective view of the underbody sub-assembly illustrating the composite body structure shown in FIG. 2 in a partially assembled state;

FIG. 10 is a perspective view of the underbody sub-assembly illustrating the composite body structure shown in FIG. 2 in a partially assembled state;

FIG. 11 is a fragmentary top view of a portion of the underbody sub-assembly illustrating the composite body structure shown in FIG. 2 in a partially assembled state;

FIG. 12 is a perspective view illustrating the composite body structure shown in FIG. 2 in a partially assembled state;

FIG. 13 is a fragmentary perspective view illustrating a portion of the composite body structure shown in FIG. 2 in a partially assembled state;

FIG. 14 is a fragmentary top view illustrating a portion of the composite body structure shown in FIG. 2 in a partially assembled state;

FIG. 15 is a fragmentary top view illustrating a portion of the composite body structure shown in FIG. 2 in a partially assembled state;

FIG. 16 is a fragmentary front view of a portion of the composite body structure shown in FIG. 2 in a partially assembled state;

FIG. 17 is a rear view of the composite body structure shown in FIG. 2 illustrating a cowl panel;

FIG. 18 is a fragmentary cross-sectional view of the composite body structure taken along line 18-18 shown in FIG. 3 illustrating a dash/cowl section;

FIG. 19 is a fragmentary cross-sectional view of the composite body structure taken along line 19-19 shown in FIG. 3 illustrating a front header section;

FIG. 20 is a fragmentary cross-sectional view of the composite body structure taken along line 20-20 shown in FIG. 3 illustrating a rear header section;

FIG. 21 is a fragmentary cross-sectional view of the composite body structure taken along line 21-21 shown in FIG. 3 illustrating a tail section;

FIG. 22 is a fragmentary cross-sectional view of the composite body structure taken along line 22-22 shown in FIG. 3 illustrating a rocker section;

FIG. 23 is a fragmentary cross-sectional view of the composite body structure taken along line 23-23 shown in FIG. 3 illustrating an a-pillar section;

FIG. 24 is a fragmentary cross-sectional view of the composite body structure taken along line 24-24 shown in FIG. 12 illustrating a b-pillar section;

FIG. 25 is a fragmentary cross-sectional view of the composite body structure taken along line 25-25 shown in FIG. 12 illustrating a b-pillar section;

FIG. 26 is a fragmentary cross-sectional view of the composite body structure taken along line 26-26 shown in FIG. 3 illustrating an a-pillar section;

FIG. 27 is a fragmentary cross-sectional view of the composite body structure taken along line 27-27 shown in FIG. 3 illustrating an a-pillar section;

FIG. 28 is a fragmentary cross-sectional view of the composite body structure taken along line 28-28 shown in FIG. 3 illustrating a quarter/sail section;

FIG. 29 is a fragmentary cross-sectional view of a portion of the composite body structure taken along line 29-29 in FIG. 4 illustrating a floor panel section;

FIG. 30 is a schematic cross-sectional view illustrating a method of applying adhesive between two panels of the composite body structure shown in FIG. 2;

FIG. 31 is a fragmentary perspective view of a composite body panel including a honeycomb core material and a layered fiber reinforcement;

FIG. 32 is a schematic view of composite material arrangements for a composite body panel; and

FIG. 33 is a fragmentary side view illustrating composite body panels joined by a bolted connection.

Corresponding reference numerals indicate corresponding parts throughout the several views of the drawings.

### DETAILED DESCRIPTION

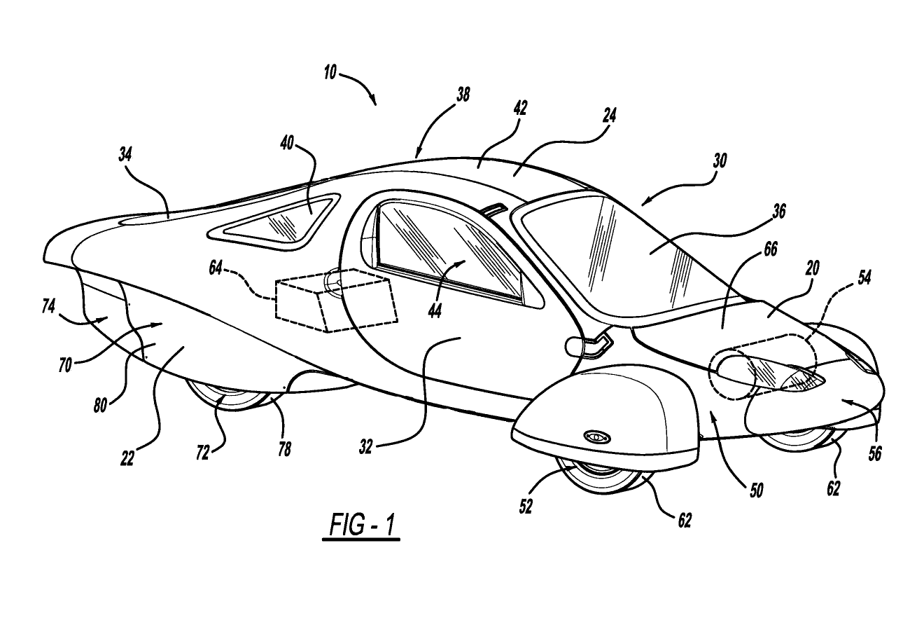

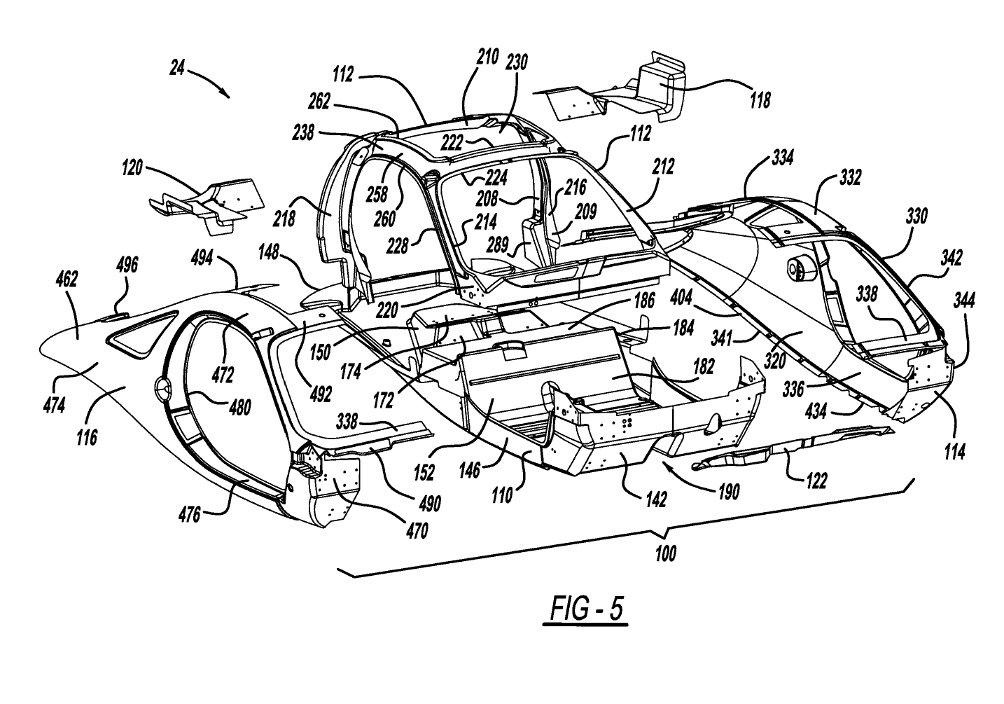

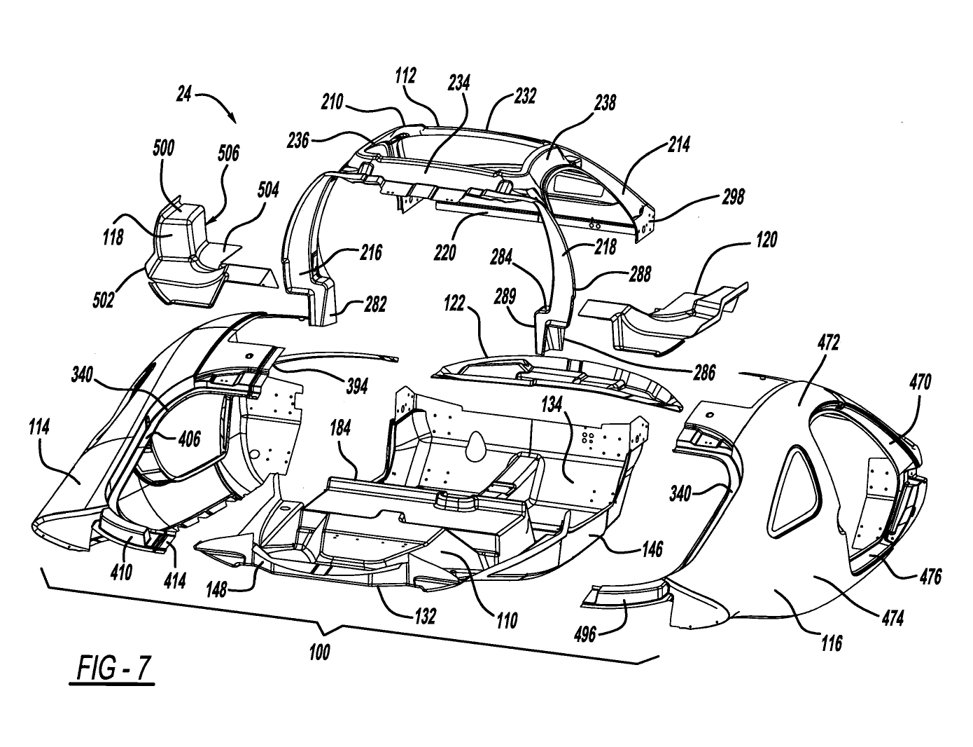

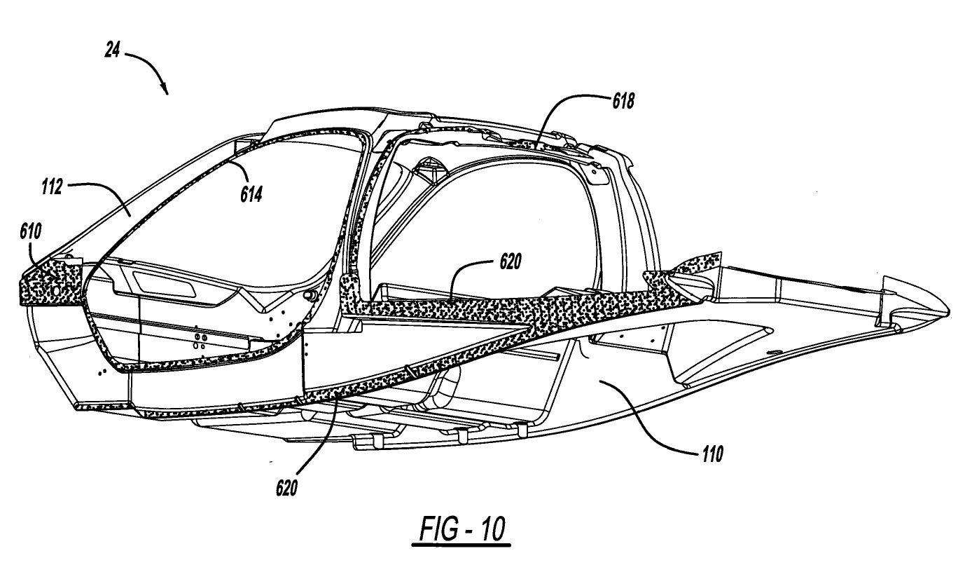

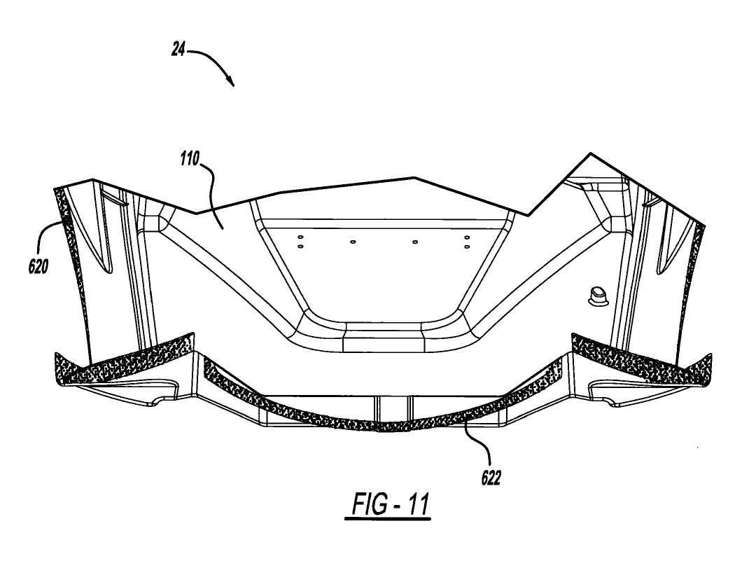

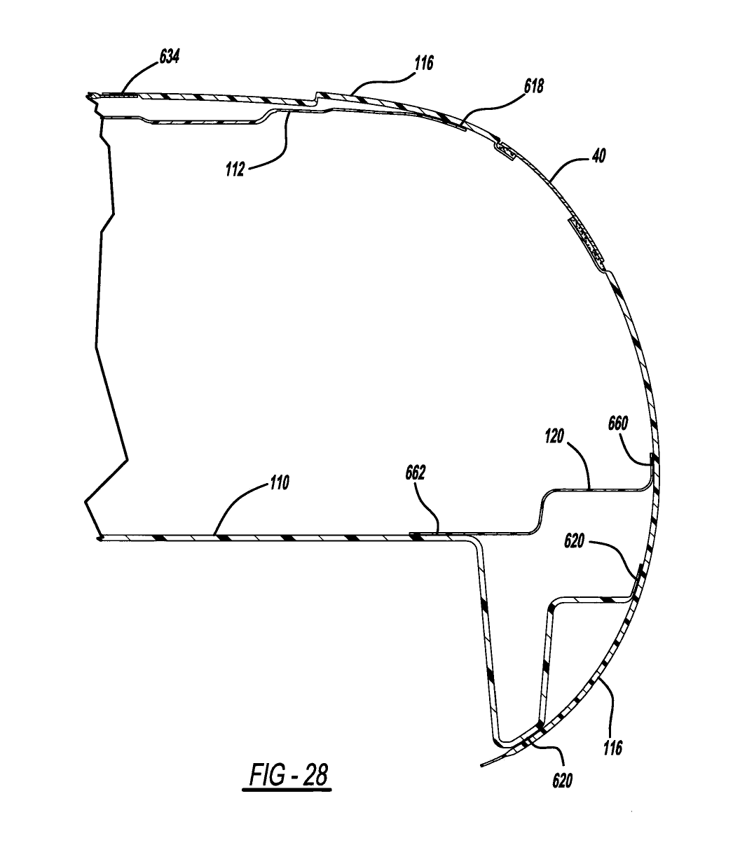

An embodiment of a composite body structure is illustrated in FIGS. 1-28. Referring to FIG. 1, an exemplary vehicle 10 according to the present disclosure is shown. Generally, vehicle 10 is a two door, three-wheeled electric vehicle having a front-wheel drive layout. However, it will be appreciated from the following description that the present invention is not limited to vehicles having a particular powerplant, layout, or number of wheels. For example, the present invention applies equally to vehicles having an internal combustion engine used alone or in combination with an electric machine (i.e., hybrid vehicles) to provide drive torque. The present invention also applies equally to front-wheel drive and rear-wheel drive vehicles.

Vehicle 10 includes a front-end module 20, a rear-end module 22, and a composite body structure 24. Vehicle 10 further includes various body closures, including doors 30, 32, a rear hatch 34, a windshield 36, rear side glass 38, 40, and a roof panel 42. Together, front-end module 20, rear-end module 22, and body structure 24 serve as a chassis of vehicle 10. In particular, front-end module 20, rear-end module 22, and body structure 24 provide the structure that supports vehicle 10. Together, body structure 24 and the body closures define a passenger compartment 44 within vehicle 10.

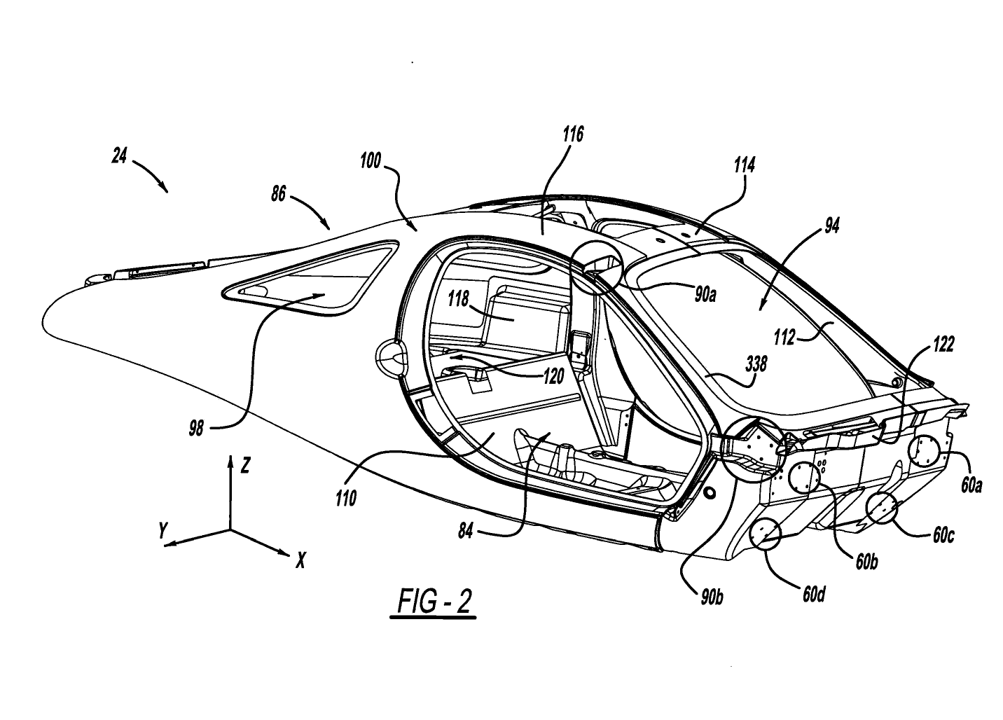

Front-end module 20 includes a front-end structure 50, a front suspension 52, an electric motor 54, and outer body panels 56. Front-end structure 50 is mounted to body structure 24 and may be mounted according to various methods. In the present example, front-end structure 50 is mounted on first mounting surfaces provided by body structure 24 via bolted connections (not shown). The mounting surfaces are provided at four locations identified by reference numerals 60a-d (FIG. 2).

Front suspension 52 includes two front wheels 62. Electric motor 54 is mounted to front-end structure 50 and is part of a drivetrain that drives the front wheels 62. An energy storage system including a rechargeable battery 64 provides energy to electric motor 54. Battery 64 is mounted to an underside of body structure 24 as described in further detail below. Outer body panels 56 are mounted to front-end structure 50 and cover portions of front-end module 20. Outer body panels 56 include a hood 66 providing selective access to components housed within front-end module 20, such as electric motor 54.

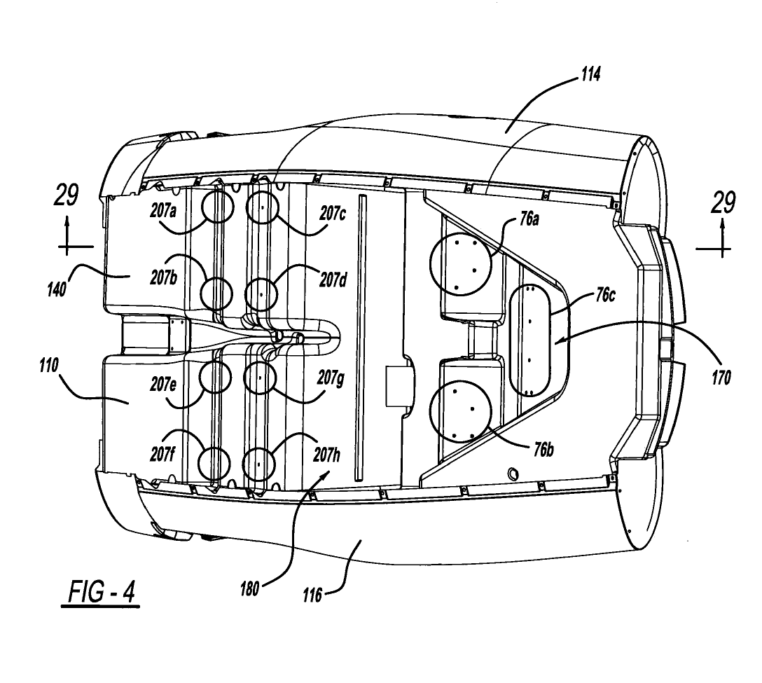

Rear-end module 22 is separate from front-end module 20 and includes a rear-end structure 70, a rear suspension 72, and outer body panels 74. Rear-end structure 70 is mounted to body structure 24 and may be mounted according to various methods. In the present example, rear-end structure 70 is mounted on second mounting surfaces provided by body structure 24 via bolted connections (not shown). The second mounting surfaces are provided at three locations identified by reference numerals 76a-c (FIG. 4). Rear suspension 72 includes a rear wheel 78. Outer body panels 74 are mounted to rear-end structure 70 and cover portions of rear-end module 22. Outer body panels 74 include an access panel 80 providing selective access to components housed within rear-end module 22, such as rear wheel 78.

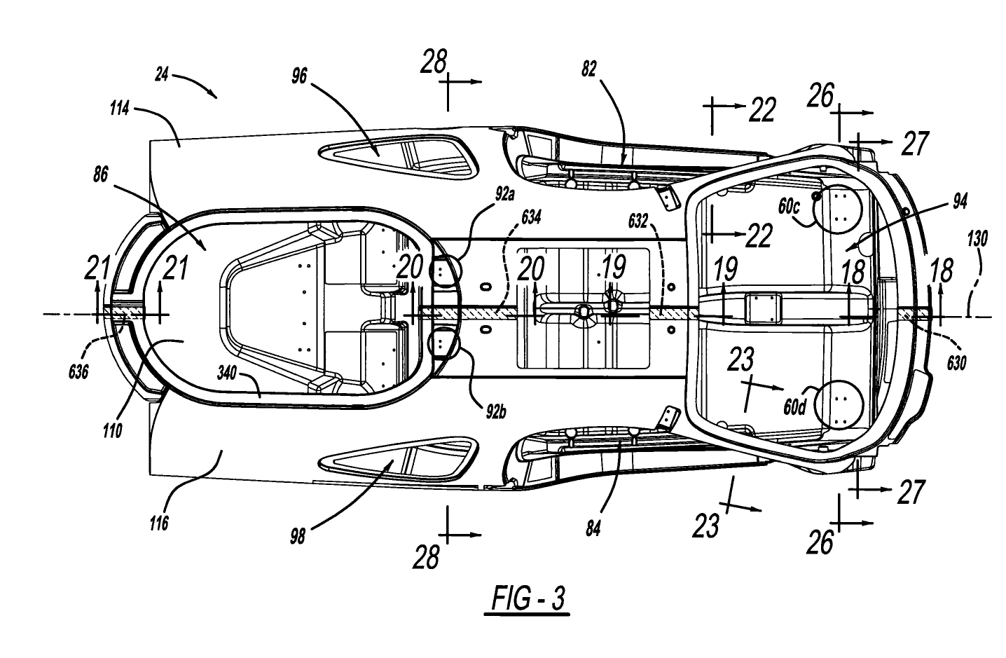

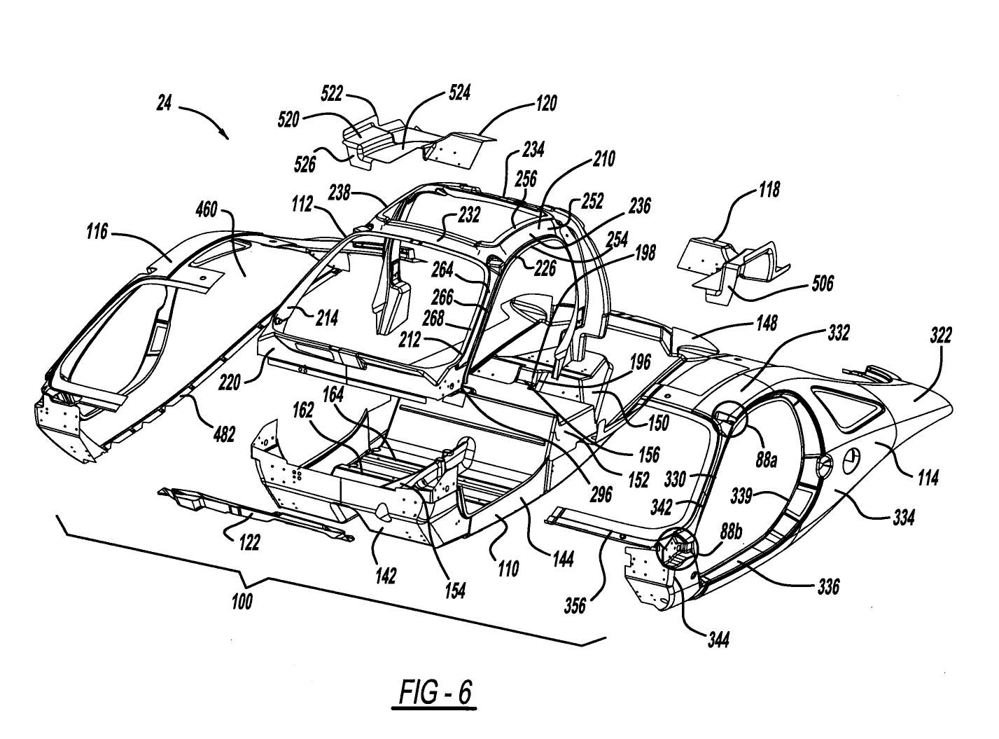

Doors 30, 32 and hatch 34 are mounted to body structure 24 within door openings 82, 84 and rear hatch opening 86, respectively, via bolted connections (not shown). Doors 30, 32 are mounted on third and fourth mounting surfaces, respectively, and hatch 34 is mounted on fifth mounting surfaces. The third, fourth, and fifth mounting surfaces are provided by the body structure 24. The third mounting surfaces are provided at two locations identified by reference numerals 88a-b (FIG. 6). The fourth mounting surfaces are provided at two locations identified by reference numerals 90a-b (FIG. 2). The fifth mounting surfaces are provided at two locations identified by reference numerals 92a-b (FIG. 3). Windshield 36 is mounted to body structure 24 within a windshield opening 94. Rear side glass 38, 40 is mounted to body structure 24 within side openings 96, 98, respectively.

With additional reference to FIGS. 2-7, body structure 24 includes a monocoque construction 100 that provides a primary structure that supports vehicle 10. In particular, body structure 24 carries loads generated by passengers and other cargo within the passenger compartment 44. Composite body structure 24 also connects front suspension 52 and rear suspension 72 and carries suspensions loads generated by vehicle 10. Composite body structure 24 further supports various body closures, such as doors 30, 32, rear hatch 34, windshield 36, and rear side glass 38, 40 and carries loads transmitted by the body closures.

Generally, monocoque construction 100 includes various composite panels joined by a structural adhesive. Various structural adhesives may be used. In the present example, the adhesive is a two-part methacrylate adhesive. The composite panels include contoured outer panels defining portions of an exterior of vehicle 10 and contoured inner panels defining portions of passenger compartment 44. The inner and outer panels typically include flanges where the panels join. The outer panels provide mounting surfaces and attachment points for various exterior components, such as the body closures. The inner panels provide mounting surfaces and attachment points for various interior components of vehicle 10, such as seats (not shown), an instrument panel (not shown), and interior trim (not shown). A construction and a thickness of the composite panels varies to provide a desired surface finish and desired structural characteristics, such as a desired strength. Exemplary constructions and thicknesses are illustrated in the drawings and discussed in further detail below.

Monocoque construction 100 includes a floor pan 110, an inner reinforcement frame structure or spider 112, a first outer panel 114, a second outer panel 116, a first closeout panel 118, a second closeout panel 120, and a cowl panel 122. Floor pan 110 extends along a longitudinal axis 130 and includes a lower surface 132 generally facing an underside of vehicle 10 and an upper surface 134 opposite lower surface 132 generally facing upward and toward an interior of vehicle 10.

Floor pan 110 includes a floor 140, a front wall 142, side walls 144, 146, and a rear wall 148. Floor 140 is a single piece part (i.e., unitary) including raised sections including a first section 150, a second section 152, tunnel sections 154, 156, and seat rail sections 158, 160, 162, 164. First section 150 is a multi-sided construction defining a suspension well 170. First section 150 includes a front wall 172 and a top wall 174 on two sides providing the mounting surfaces for the rear suspension 72. Second section 152 is a multi-sided construction defining a battery well 180. Second section 152 includes a front wall 182, a ridge 184, and a top wall 186. Ridge 184 extends between front wall 182 and top wall 186 in a longitudinal direction and between sides of second section 152.

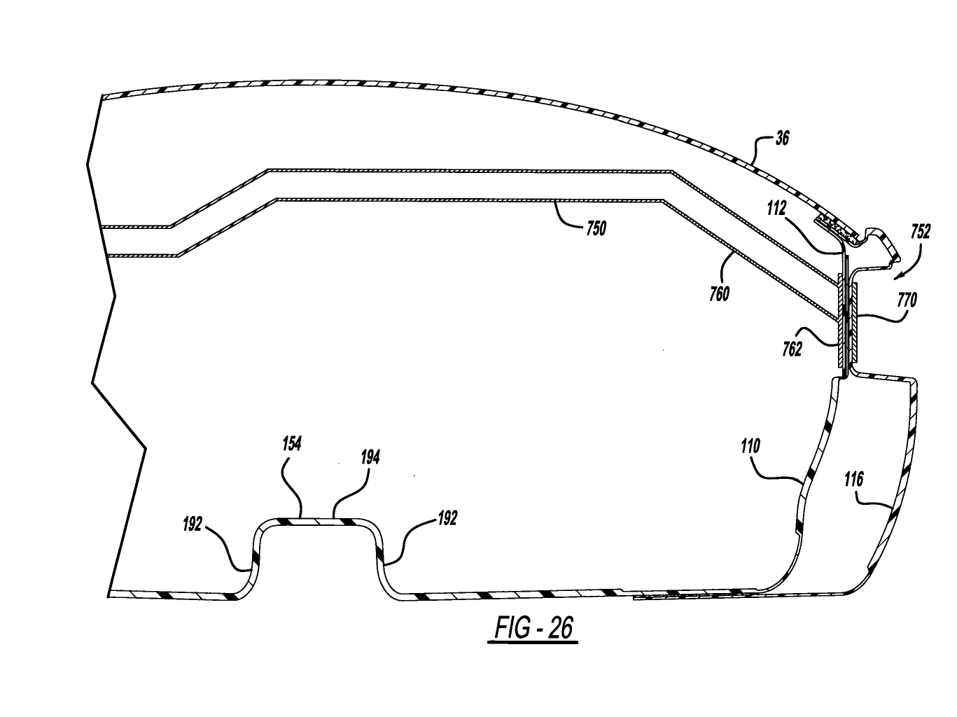

Tunnel sections 154, 156 define a longitudinally extending tunnel 190. Tunnel section 154 longitudinally extends between and connects front wall 142 and front wall 182. With additional reference to FIG. 26, Tunnel section 154 includes side walls 192 and a top wall 194. Tunnel section 156 longitudinally extends between and connects first section 150 and second section 152. Tunnel section 156 includes side walls 196 extending from a top wall 198.

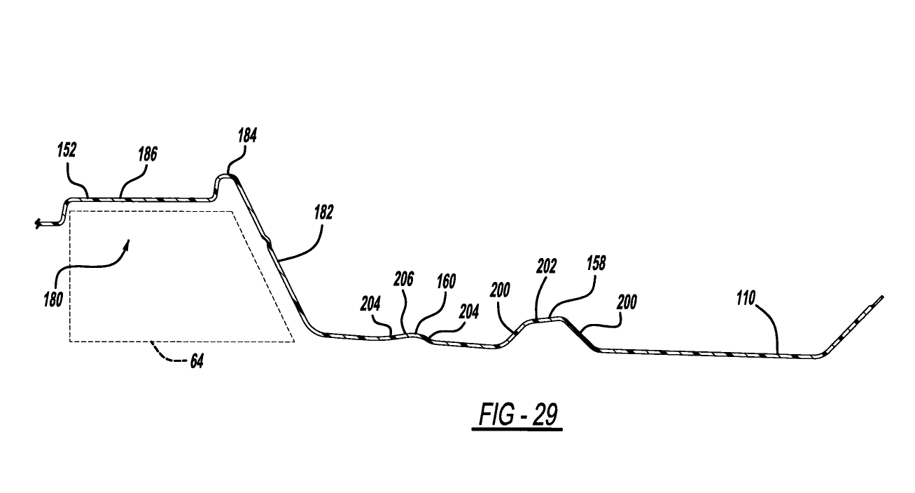

Seat rail sections 158, 160 longitudinally extend between and connect side wall 144 and tunnel section 154. Seat rail sections 162, 164 longitudinally extend between and connect side wall 146 and tunnel section 154. Seat rail sections 158, 160 can be substantially similar to seat rail sections 162, 164, respectively. For brevity, seat rail sections 158, 160 will be described with the understanding that the following description applies equally to seat rail sections 162, 164. Seat rail section 158 is longitudinally spaced apart from seat rail section 160. With additional reference to FIG. 29, seat rail section 158 includes side walls 200 and a top wall 202. Seat rail section 160 includes side walls 204 and a top wall 206. Top walls 202, 204 and side walls 200 and 204 provide mounting surfaces for a seat (not shown) as indicated by reference numerals 207a-h in FIG. 4.

Spider 112 is mounted on floor pan 110 and surrounds a majority of an upper portion of the passenger compartment 44. Spider 112 is a single piece part including an inner surface 208 generally facing the interior and an outer surface 209 opposite inner surface 208 generally facing the exterior. Spider 112 further includes a frame 210, vertically extending support members 212, 214, 216, 218, and laterally extending support member 220. Together, frame 210 and support members 212, 214, 216, 218, 220 define a roof bond flange 222, an inner windshield bond flange 224, and inner body side opening flanges 226, 228. Roof bond flange 222 surround and define part of a roof opening 230. Inner windshield bond flange 224 surrounds and defines part of windshield opening 94. Inner body side opening flanges 226, 228 surround and define parts of door openings 82, 84, respectively.

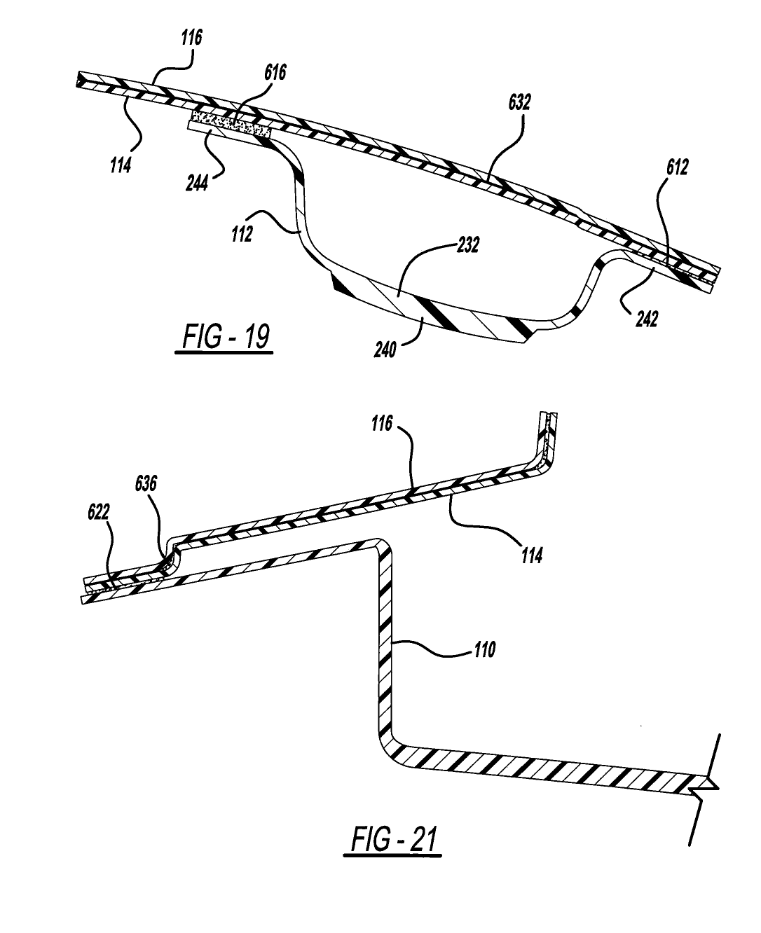

Frame 210 includes header rails 232, 234, and side rails 236, 238. Header rail 232 extends laterally between and connects support members 212, 214 and creates part of a front header section as illustrated in FIG. 19. Header rail 232 includes a contoured section 240, a forward flange 242, a rearward flange 244. Contoured section 240 extends between flanges 242, 244 and has a generally U-shape cross-section.

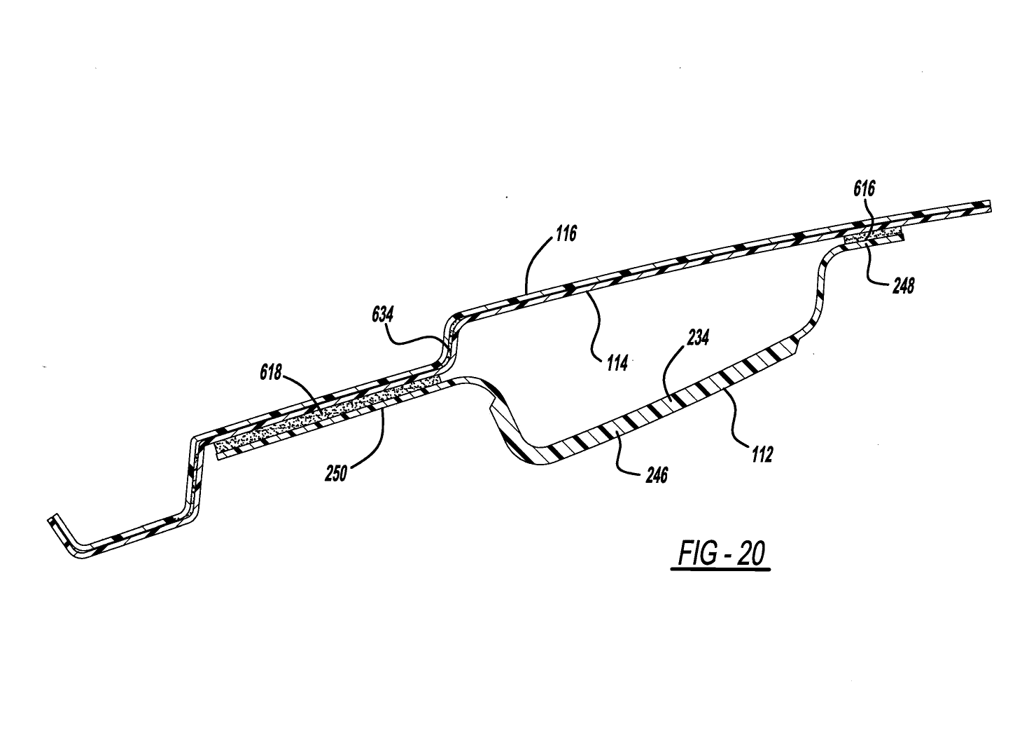

Header rail 234 extends laterally between and connects support members 216, 218 and creates part of a rear header section as illustrated in FIG. 20. Header rail 234 includes a contoured section 246, a forward flange 248, and a rear flange 250. Contoured section 246 extends between flanges 248, 250 and has a generally U-shape cross-section.

Side rail 236 longitudinally extends between and connects support members 212, 216 and includes a contoured section 252, an outer flange 254, and an inner flange 256. Side rail 238 longitudinally extends between and connects support members 214, 218 and includes a contoured section 258, an outer flange 260, and an inner flange 262.

Support members 212, 214 create parts of corresponding a-pillar sections as illustrated in FIG. 23 for support member 214. Support member 212 includes a contoured section 264, an outer flange 266, and an inner flange 268. Support member 214 includes a contoured section 270, an outer flange 272, and an inner flange 274. Contoured section 270 extends between flanges 272, 274 and has a generally U-shape cross-section.

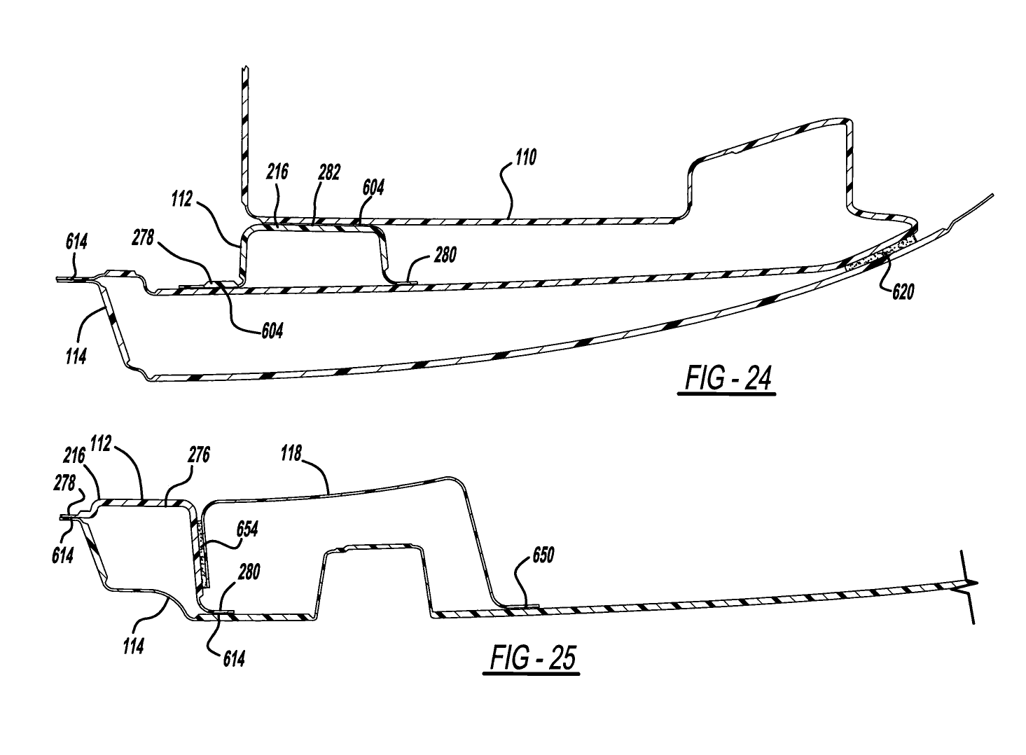

Support members 216, 218 create parts of corresponding b-pillar sections as illustrated in FIGS. 24-25. Support member 216 includes a contoured section 276, a forward flange 278, and a rearward flange 280. Contoured section 276 extends between flanges 278, 280 and has a generally U-shape cross-section. Contoured section 276 includes a vertical wall 282. Vertical wall 282 is joined to a complementary side wall of second section 152.

Support member 218 includes a contoured section 284, a forward flange 286, and a rearward flange 288. Contoured section 284 extends between flanges 286, 288 and has a generally U-shape cross-section. Contoured section 282 includes a vertical wall 289. Vertical wall 289 is joined to a complementary side wall of second section 152.

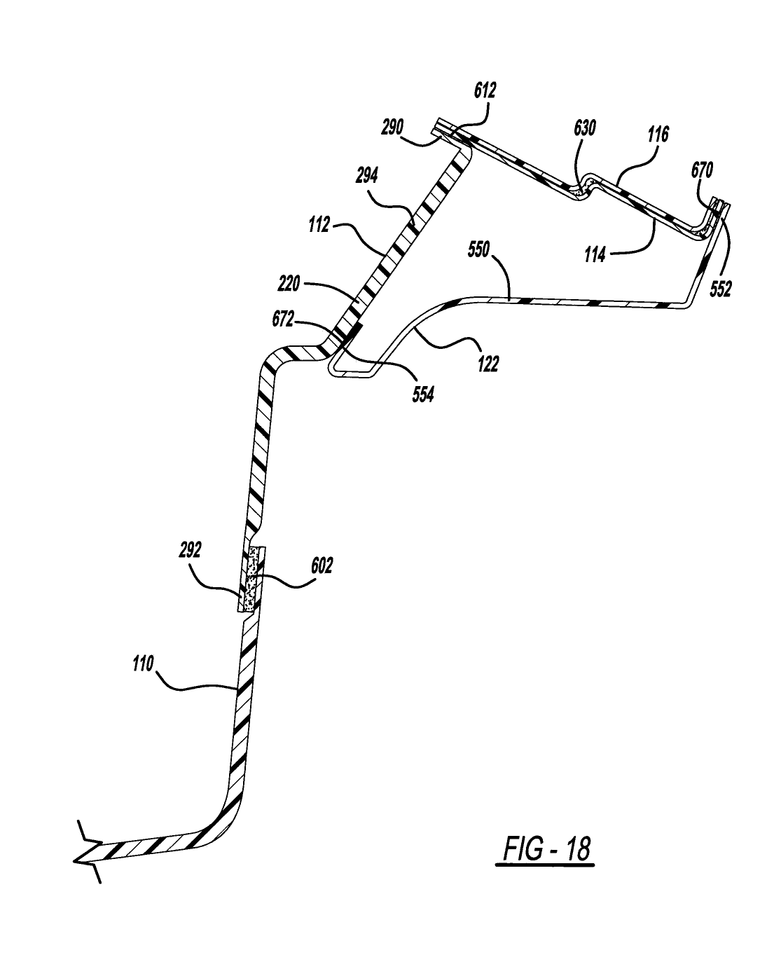

Support member 220 extends laterally between and connects ends of support members 212, 214 opposite frame 210 and creates part of a dash/cowl section as illustrated in FIG. 18. Support member 220 includes an upper flange 290, a lower flange 292, a contoured section 294, and end caps 296, 298. Contoured section 294 extends between upper and lower flanges 290, 292 and end caps 296, 298 and generally has a U-shape cross-section. Upper flange 290 is joined to first outer panel 114. Lower flange 292 is joined to floor pan 110. End caps 296, 298 include vertical walls that are joined to floor pan 110. End cap 296 is joined to front wall 142 and side wall 144. End cap 298 is joined to front wall 142 and side wall 146.

First outer panel 114 is joined to floor pan 110 and spider 112. First outer panel 114 is a single piece part including an inner surface 320 and an outer surface 322. Outer surface 322 includes portions having a Class-A surface. Although first outer panel 114 may be a single part as discussed herein, first outer panel 114 may be segmented into more than one part. For example, first outer part 114 may include a first part including the Class-A surface and a second part including a non-Class-A surface.

First outer panel 114 further includes an a-pillar part 330, a roof panel part 332, a quarter panel part 334, and a rocker panel part 336. Together, a-pillar part 330, roof panel part 332, quarter panel part 334, and rocker panel part 336 create contiguous portions of an outer windshield bond flange 338, an outer door opening flange 339, a rear hatch sealing flange 340, and a lower bonding flange 341. Outer windshield bond flange 338 defines windshield opening 94. Outer door opening flange 339 defines door opening 82. Rear hatch sealing flange 340 defines rear hatch opening 86. Lower bonding flange 341 extends along a lower portion of first outer panel 114 and is used to bond first outer panel 114 to floor pan 110.

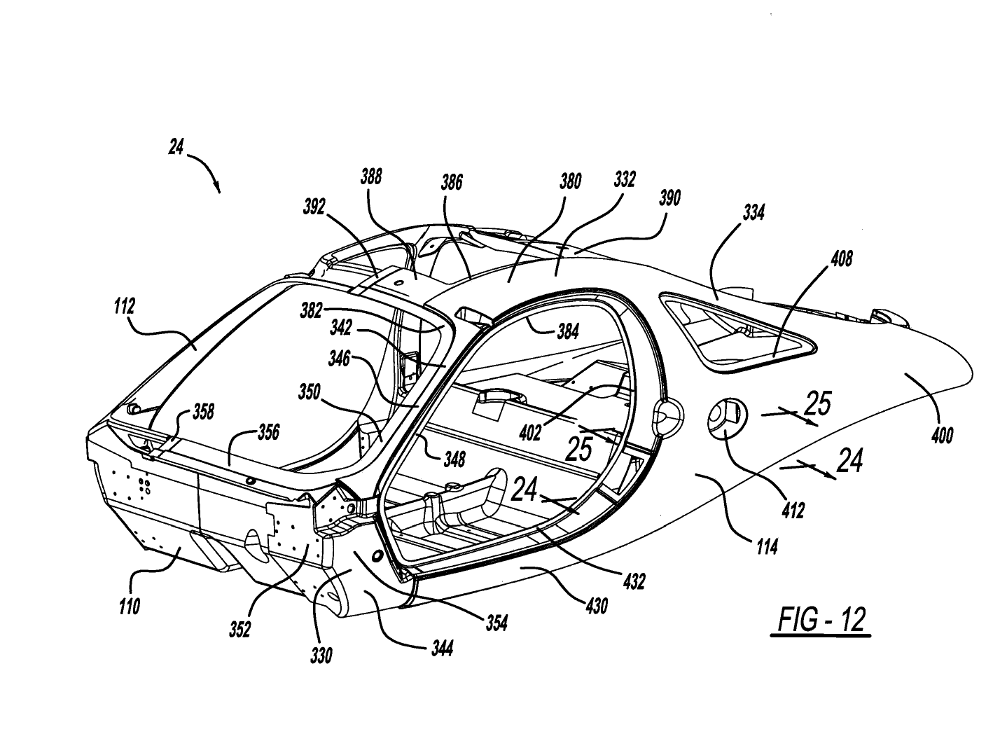

A-pillar part 330 extends from forward ends of roof panel part 332 and rocker panel part 336 and includes a portion of inner and outer surfaces 320, 322. In alternate implementations, a-pillar part 330 can be a separate part joining roof panel part 332 and rocker panel part 336. A-pillar part 330 includes a first section 342 at an upper end and a second section 344 at a lower end. First section 342 creates part of an a-pillar section substantially similar to the a-pillar section illustrated in FIG. 23. First section 342 includes a contoured section 346 and flanges 348, 350 (see FIG. 12). Second section 344 extends from first section 342 and includes adjoining wall sections 352, 354, and a tie rail 356. Second section 344 further includes the lower mounting surface for door 30 at location 88b (FIG. 6). Tie rail 356 extends from wall sections 352, 354 and includes a stepped flange 358 at an end opposite wall sections 352, 354.

Roof panel part 332 extends from a-pillar part 330 to an upper end of quarter panel part 334 and includes a portion of inner and outer surfaces 320, 322. Roof panel part 332 further includes a contoured section 380, flanges 382, 384, 386 and tie rails 388, 390. Contoured section 380 extends between flanges 382, 384, 386 and tie rails 388, 390. Contoured section 380 includes the upper mounting surface for door 30 at location 88a (FIG. 6). Flange 382 includes a portion of outer windshield bond flange 338. Flange 384 includes a portion of outer door opening flange 339. Flange 386 defines a portion of roof opening 230. Tie rails 388, 390 include stepped flanges 392, 394, respectively, that join to complementary portions of second outer panel 116 and create a contiguous surface between first and second outer panels 114, 116.

Quarter panel part 334 extends from ends of a-pillar part 330 and rocker panel part 336 to rear wall 148 of floor pan 110 and includes a portion of inner and outer surfaces 320, 322. Quarter panel part 334 further includes a contoured section 400, flanges 402, 404, 406, 408, and a tie rail 410. Contoured section 400 extends between flanges 402, 404, 406, 408, and tie rail 410. Contoured section 400 includes an access pocket 412 for receiving a plug (not shown) for charging battery 64. Flange 402 includes a portion of outer door opening flange 339. Flange 404 includes a portion of lower bonding flange 341 Flange 406 includes a portion of rear hatch sealing flange 340. Flange 408 includes a portion of a bonding flange for side glass 38. Tie rail 410 laterally extends from a rear end of quarter panel part 334 and includes a stepped flange 414 at an inboard end. Stepped flange 414 is joined to complementary portions of second outer panel 116 and creates a contiguous surface between first and second outer panels 114, 116.

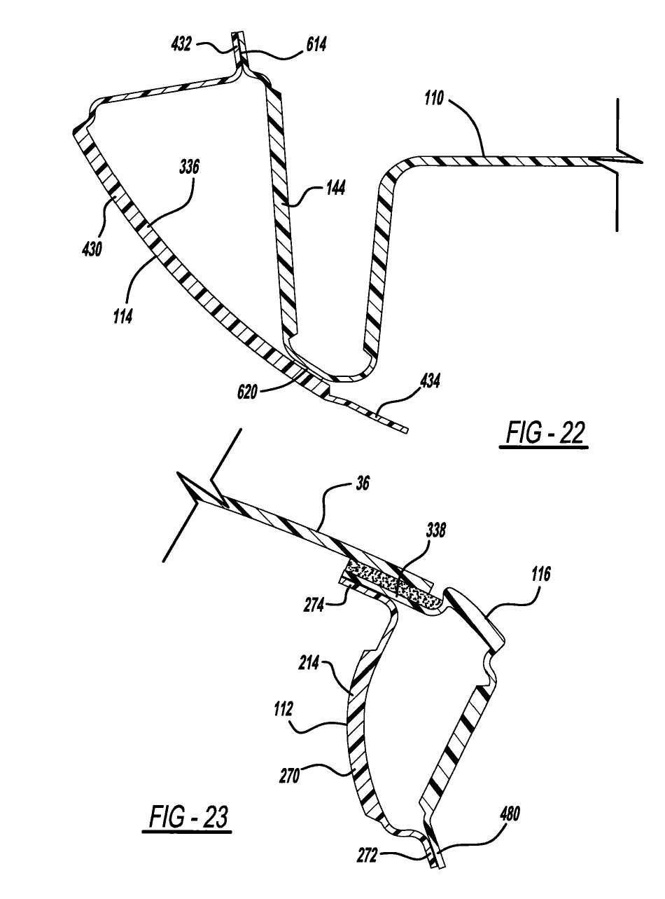

Rocker panel part 336 extends between a-pillar part 330 and quarter panel part 334 and creates a rocker section as illustrated in FIG. 22. The rocker section extends rearward to a location adjacent a rear end of second section 152. Rocker panel part 336 includes a portion of inner and outer surfaces 320, 322. Rocker panel part 336 further includes a contoured section 430 and flanges 432, 434. Contoured section 430 extends between flanges 432, 434. Flange 432 includes a portion of outer door opening flange 339. Flange 434 includes portions of lower bonding flange 341.

Second outer panel 116 is joined to floor pan 110 and spider 112. Generally, second outer panel 116 is a mirror image of first outer panel 114. Second outer panel 116 is a single piece part including an inner surface 460 and an outer surface 462. First outer panel 114 further includes an a-pillar part 470, a roof panel part 472, a quarter panel part 474, and a rocker panel part 476. Together, a-pillar part 470, roof panel part 472, quarter panel part 474, and rocker panel part 476 create a contiguous second portion of outer windshield bond flange 338 and a contiguous second portion of rear hatch sealing flange 340. A-pillar part 470, roof panel part 472, quarter panel part 474, and rocker panel part 476 further create an outer door opening flange 480 and a lower bonding flange 482. Outer door opening flange 480 defines portions of door opening 84. Lower bonding flange 482 extends along a lower portion of second outer panel 116 and joins a lower portion of second outer panel 114 to floor pan 110.

A-pillar part 470, roof panel part 472, quarter panel part 474, and rocker panel part 476 include features substantially similar to the features of a-pillar part 330, a roof panel part 332, a quarter panel part 334, and a rocker panel part 336 discussed above. Accordingly, for brevity, the differences will be discussed. A-pillar part 470 includes a tie rail 490 substantially similar to tie rail 356, except an end of tie rail 490 is complementary to stepped flange 358. Similarly, roof panel part 472 includes tie rails 492, 494 having ends complementary to stepped flanges 392, 394 of tie rails 388, 390, respectively. Quarter panel part 474 includes a tie rail 496 having an end complementary to stepped flange 414 of tie rail 410.

First closeout panel 118 is joined to floor pan 110, spider 112, and first outer panel 114. Together, first closeout panel 118, floor pan 110, and spider 112 create a b-pillar section substantially similar to the b-pillar section illustrated in FIG. 25. The b-pillar section is coupled to the rocker section created by floor pan 110 and first outer panel 114 illustrated in FIG. 22.

First closeout panel 118 includes a contoured section 500, flanges 502, 504, and a front wall 506. Contoured section 500 extends between flanges 502, 504, and front wall 506. Flange 502 is located at an outboard side and is joined to a complementary portion of inner surface 320. Flange 504 is located at a lower portion and is joined to a complementary adjoining portion of upper surface 134. Front wall 506 extends vertically and is joined to a complementary adjoining portion of inner surface 208.

Second closeout panel 120 is joined to floor pan 110, spider 112, and second outer panel 116. Together, second closeout panel 120, floor pan 110, spider 112, and second outer panel 116 create portions of a b-pillar section substantially similar to the b-pillar section illustrated in FIG. 25. The b-pillar section is coupled to a rocker section created by floor pan 110 and second outer panel 116 substantially similar to the rocker section illustrated in FIG. 22.

Second closeout panel 120 includes a contoured section 520, flanges 522, 524, and a front wall 526. Contoured section 520 extends between flanges 522, 524 and front wall 526. Flange 522 is located at an outboard side and is joined to inner surface 460. Flange 524 is located at a lower portion and is joined to a complementary portion of upper surface 134.

Cowl panel 122 extends in a longitudinal direction and is joined to spider 112, first outer panel 114, and second outer panel 116, thereby creating a portion of a dash/cowl section as illustrated in FIG. 18. Cowl panel 122 includes a contoured section 550 and flanges 552, 554. Contoured section 550 extends between flanges 552, 554. Flange 552 extends along an upper portion and is joined to inner surfaces 320, 460. Flange 554 extends along a lower portion and is joined to support member 220.

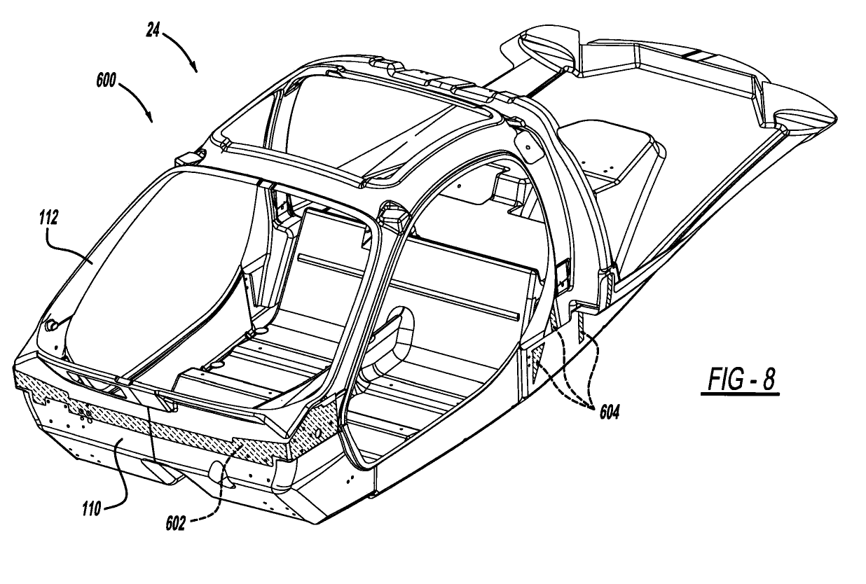

Referring to FIGS. 8-17, a preferred method of joining the various panels during assembly of monocoque construction 100 is illustrated. First, as shown in FIG. 8, spider 112 is joined to floor pan 110, thereby creating an underbody assembly 600. More specifically, an adhesive 602 joins front and side portions of support member 220 to complementary portions of front wall 142 and side walls 144, 146. an adhesive 604 joins flanges 278, 280 to side walls 144 and vertical wall 282 to complementary sidewalls of second section 152. Although not specifically shown in FIG. 8, adhesive joins support 218 to floor pan 110 in a similar manner as adhesive 604.

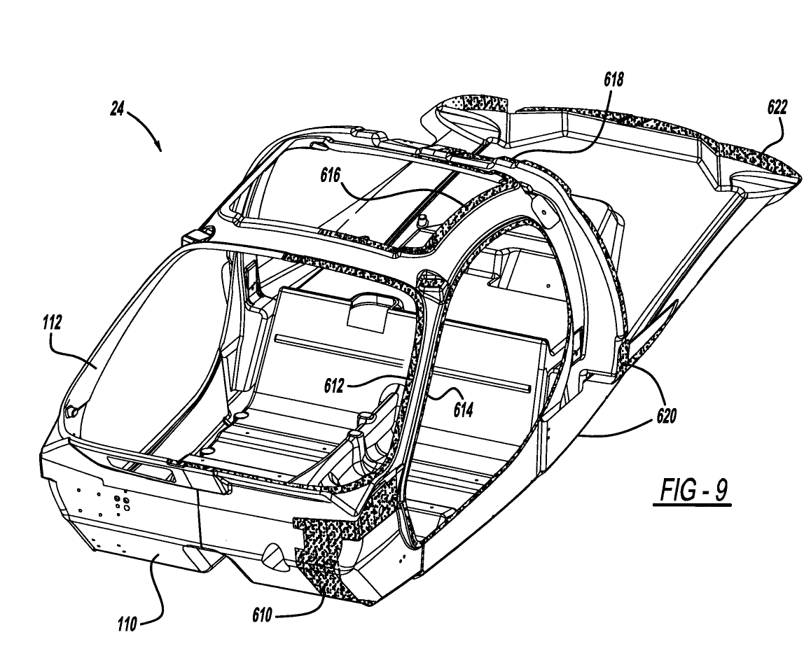

Next, as shown in FIGS. 9-12, first outer panel 114 is joined to floor pan 110 and spider 112. Adhesive 610, 612, 614 joins forward portions of underbody assembly 600 to complementary portions of a-pillar part 330. Adhesive 612, 614 and adhesive 616, 618 joins an upper portion of underbody assembly 200 to roof panel part 332. Adhesive 614, 616 and adhesive 620, 622 joins a portion of underbody assembly 600 to quarter panel part 334.

Next, second outer panel 116 is joined to floor pan 110, spider 112, and first outer panel 114. Second outer panel 116 is joined to the floor pan 110 and spider 112 using structural adhesive in a substantially similar way as described above for first outer panel 114 and thus will not be described in detail. Referring back to FIG. 3, structural adhesive 630, 632, 634, 636 joins tie rails 356, 388, 390, 410 to tie rails 490, 492, 494, 496, respectively.

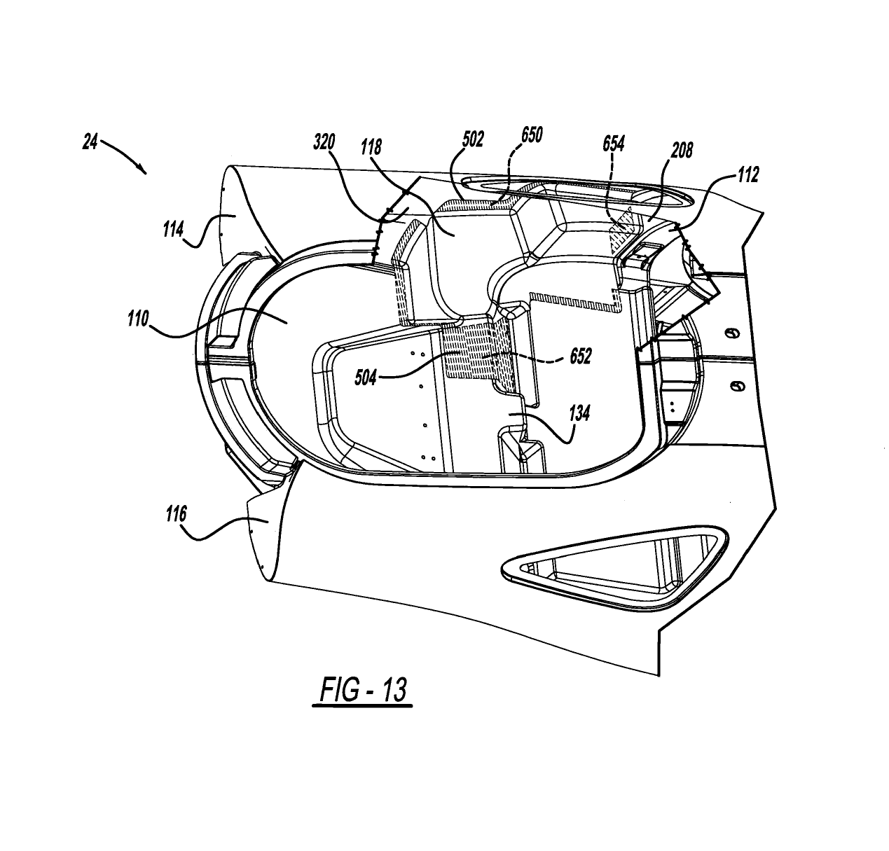

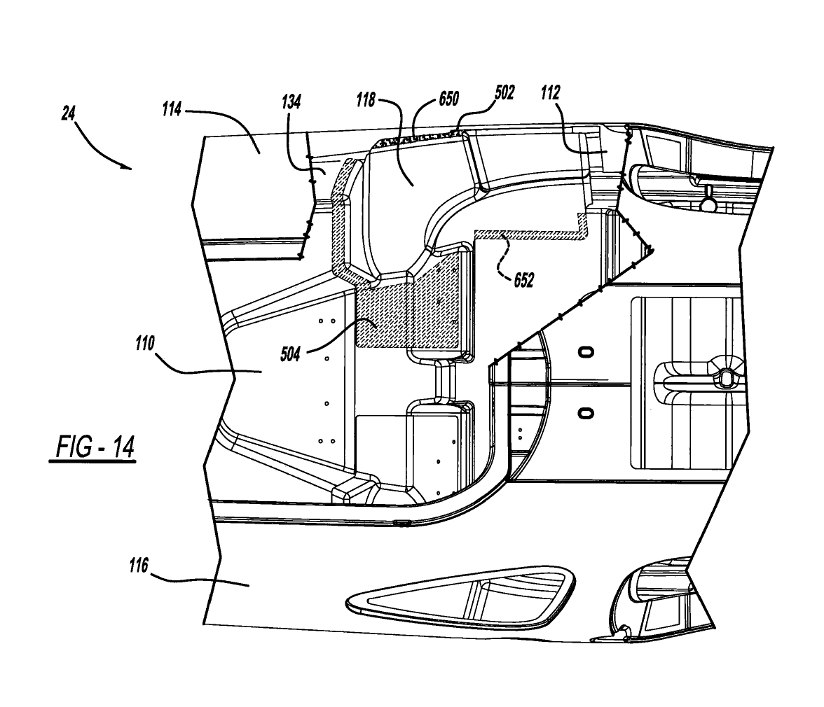

Next, as shown in FIGS. 13-14, first closeout panel 118 is joined to floor pan 110, spider 112, and first outer panel 114. An adhesive 650 joins flange 502 to inner surface 320. An adhesive 652 joins flange 504 to upper surface 134. An adhesive 654 joins front wall 506 to inner surface 208.

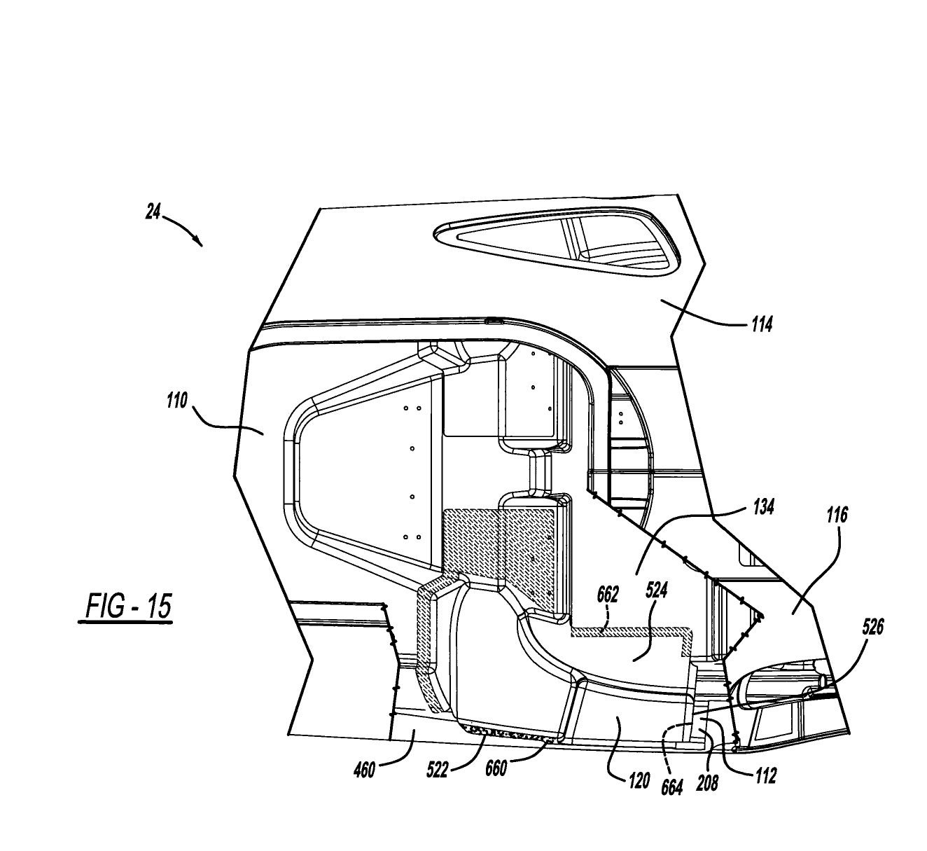

Next, as shown in FIG. 15, second closeout panel 120 is joined to floor pan 110, spider 112, and second outer panel 116. An adhesive 660 joins flange 522 to inner surface 460. An adhesive 662 joins flange 524 to upper surface 134. An adhesive 664 joins front wall 526 to inner surface 208.

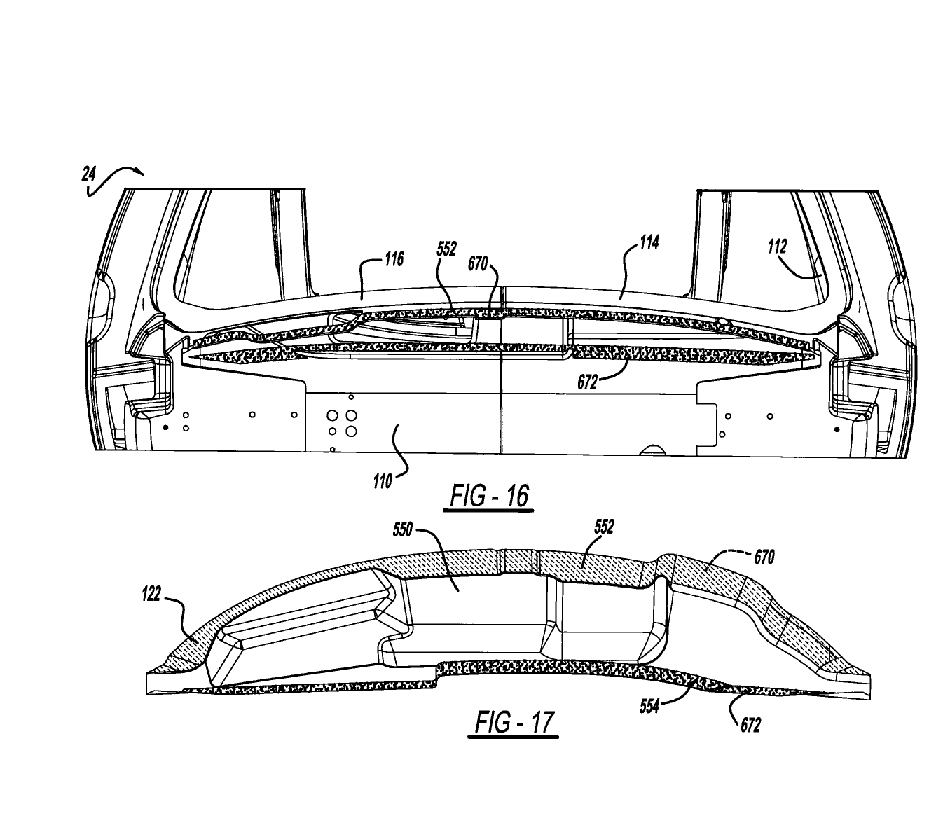

Next, with reference to FIGS. 16-17, cowl panel 122 is joined to spider 112, first outer panel 114, and second outer panel 116. An adhesive 670 joins flange 552 to inner surface 320. An adhesive 672 joins flange 554 to inner surface 460.

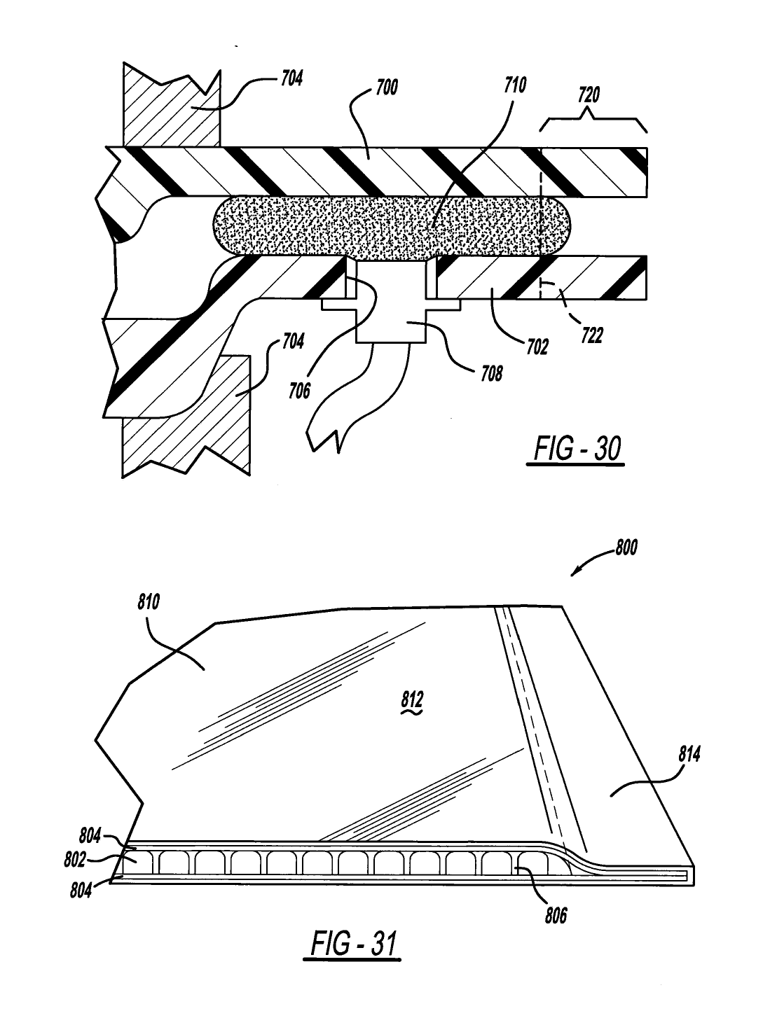

The present invention is not limited to a particular method for adhesively joining the composite panels of composite body structure 24. Referring now to FIG. 30, a preferred method for joining two panels of composite body structure 24 will now be described. First, two panels 700, 702 to be joined are brought into close proximity using fixtures or tooling 704. While fixtures 704 hold panels 700, 702 in place, a through hole 706 is drilled in one of panels 700, 702 in an area where adhesive is to be used. Hole 706 may be drilled by hand using a drill fixture (not shown) or, alternatively, by automated methods. It is also contemplated that hole 706 may be preformed in one of panels 700, 702. A head of an adhesive dispenser 708 is inserted in hole 706 and a desired amount of adhesive 710 is pumped into a gap between panels 700, 702. Once the desired amount is delivered, adhesive dispenser 708 may be removed from panel 702 and adhesive 710 is cured. Depending on the location of adhesive, it may be desired to remove a portion 720 of panels 700, 702 and adhesive 710 to provide a finished surface 722.

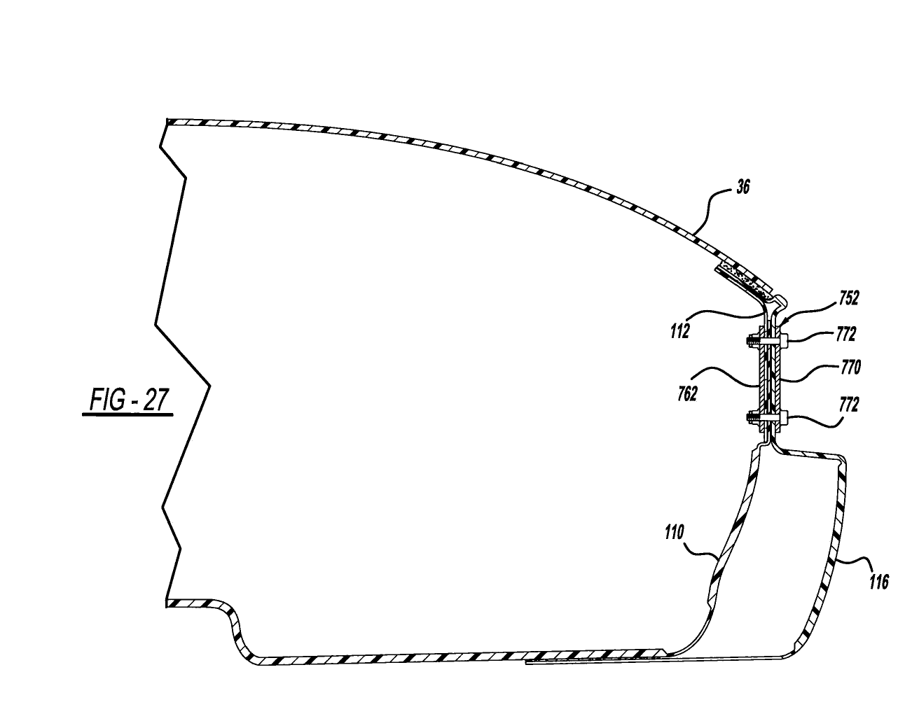

Referring to FIGS. 26-27, cross-sectional views taken along lines 26-26, 27-27 of FIG. 3 illustrate additional a-pillar sections showing a cross-car beam 750 mounted to composite body structure 24 via connections 752. Cross-car beam 750 serves as a support for an instrument panel (not shown) and provides additional lateral structure for resisting a side impact. Cross-car beam 750 can be composed of various materials. For example, cross-car beam can be composed of various metals, such as steel and aluminum. Alternately, or additionally, cross-car beam 750 can be composed of a composite material. Cross-car beam 750 includes a tubular structure 760 extending between and connected to end plates 762. Connections 752 are bolted connections in which portions of floor pan 110, spider 112, and first and second outer panels 114, 116 are held between end plates 762 and hinges 770 supporting doors 30, 32. For example, on the right side of vehicle 10, portions of floor pan 110, spider 112, and second outer panel 116 are held between one of end plates 762 as shown. Bolts 772 secure the connection.

Referring now to FIG. 31, an automotive vehicle composite panel 800 is shown as a multi-layer structure including varying arrangements of a core layer 802 and reinforcement layers 804. During manufacture, reinforcement layers 804 are stacked around core layer 802 and then vacuum impregnated with a resin 806, so as to provide a composite structure having enhanced structural properties. A first structural region 810 of composite panel 800 includes core layer 802 sandwiched between reinforcement layers 804 with resin 806 interspersed therebetween. This arrangement mechanically secures core layer 802 to reinforcement layers 804, while still providing resin 806 as a high gloss, Class-A finish on an outer surface 812.

A second structural region or flange 814 is contiguous with first structural region 810 and is located around the perimeter of composite panel 800. Flange 814 includes only reinforcement layers 804 impregnated with resin 806. Removal of core layer 802 provides flange 814 with a reduced weight and thickness as compared to first structural region 810. The arrangement of flange 814 provides a finished end to composite panel 800, but also provides a region for securement to other materials and components, such as, secondary composite panels, metallic flanges, etc. These additional components can be secured to flange 814 by securing an attachment mechanism therewith.

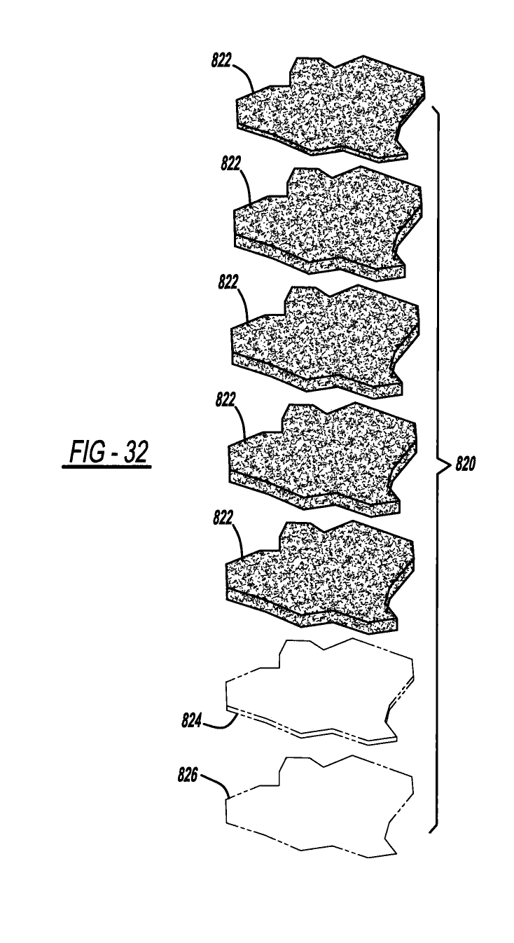

Various laminar structures can be used with composite panel 800. For example, FIG. 32 illustrates a laminar structure 820, typically used for flange 814. Laminar structure 820 includes multiple layers of carbon-free fiber material 822. Laminar structure 820 may optionally include a veil sheet 824 and/or a paint layer 826. If used, veil sheet 824 is located immediately adjacent carbon-free fiber material 822 and within cured resin material. Accordingly, veil sheet 824 is disposed between paint layer 826 and corresponding carbon-free fiber material 822. Veil sheet 824 assists in preventing print-through of carbon-free fiber material 822, while still offering abrasion and impact resistance. Paint layer 826 is adhered to outer surface 812 of composite panel 800 for providing a high gloss, Class-A surface on composite panel 800, thereby allowing composite panel 800 to be used as an exterior surface. As should be understood, veil sheet 824 and/or paint layer 826 are only provided as an optional configuration.

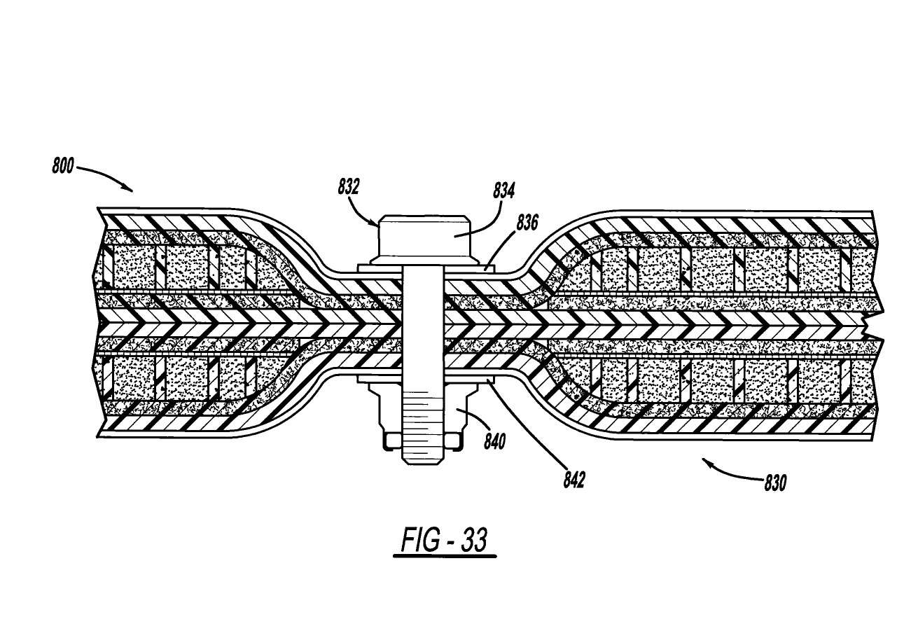

Referring now to FIG. 33, certain elements may be secured to composite panel 800 during vehicle assembly. For example, a second composite panel 830 may be secured to composite pane! 800 with a fastener arrangement 832. Fastener arrangement 832 may include a bolt 834 and a washer or hardware 836 in contact with composite panel 800 at a reduced thickness laminar region. A nut 840 and a washer or hardware 842 may be secured to bolt 834 so as to be in contact with second composite panel 830. While securement of similarly designed composite panels 800, 830 is described, it should be understood that various other components may also be secured to composite panel 800 with fastener arrangement 832 in substantially the same manner.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. It is intended by the following claims to cover these and any other departures from the disclosed embodiments which fall within the true spirit of this invention.

1. An automotive vehicular structure, comprising:
(a) a composite first body side outer panel including:
a first side panel extending in a substantially longitudinal direction on a first side and defining at least an entire first door opening; and
a first connecting panel extending from the first side panel in a first substantially transverse direction; and
(b) a composite second body side outer panel including:
a second side panel extending in the substantially longitudinal direction on a second side opposite the first side and defining at least an entire second door opening; and
a second connecting panel extending from the second side panel in a second substantially transverse direction opposite the first transverse direction, the second connecting panel being directly attached to the first connecting panel at a location between the first side panel and the second side panel.

2. The automotive vehicular structure of claim 1, wherein the first body side outer panel includes a mounting surface for a door.

3. The automotive vehicular structure of claim 1, wherein the first body side outer panel includes an engagement surface for a body closure.

4. The automotive vehicular structure of claim 3, wherein the engagement surface is one of a window glass mounting surface and a body closure sealing surface.

5. The automotive vehicular structure of claim 1, wherein the first and second connecting panels overlap.

6. The automotive vehicular structure of claim 1, wherein the first connecting panel overlaps the second connecting panel at a plurality of attachment locations.

7. The automotive vehicular structure of claim 1, wherein the first and second body side outer panels are entirely composed of materials free of carbon fiber.

8. An automotive vehicular apparatus, comprising:
a composite floor pan including a floor of a passenger compartment and;
a composite structure joined to the floor pan and substantially surrounding at least a majority of an upper portion of the passenger compartment, the structure including a roof member and elongated support members extending from the roof member to the floor pan; and
a composite first outer panel joined to the floor pan and the structure in a monocoque construction, the first outer panel being entirely composed of materials free of carbon fiber.

9. The automotive vehicular apparatus of claim 8, wherein the first outer panel is a body side panel extending along a length of the floor pan.

10. The automotive vehicular apparatus of claim 8, wherein the first outer panel includes a Class-A surface.

11. The automotive vehicular apparatus of claim 8, wherein the floor pan further includes a first suspension mounting surface and a separate second suspension mounting surface.

12. The automotive vehicular apparatus of claim 8, wherein the first outer panel supports a body closure.

13. The automotive vehicular apparatus of claim 8, wherein at least one of the floor pan and the structure is entirely composed of materials free of carbon fiber.

14. An automotive vehicular structure, comprising:
(a) a composite first body side outer panel extending in a substantially longitudinal direction on a first side and defining at least an entire first body side opening, the first body side outer panel including:
(i) a first roof panel part including a first tie rail extending in a first substantially transverse direction;
(ii) a first rocker panel part;
(iii) a first A-pillar part connecting the roof panel part and the rocker panel part, the A-pillar part including a second tie rail extending in the first substantially transverse direction; and
(iv) a first quarter panel part connecting the roof panel part and the rocker panel part, the first quarter panel part including a third tie rail extending in the first substantially transverse direction; and
(b) a composite second body side outer panel extending in the substantially longitudinal direction on a second side opposite the first side and defining at least an entire second body side opening, the second body side outer panel being directly attached to the first body side outer panel at a location between the first side and the second side.

15. The automotive vehicular structure of claim 14, wherein the second body side outer panel includes:
(a) a second roof panel part including a fourth tie rail directly attached to the first tie rail at a first location;
(b) a second rocker panel part;
(c) a second A-pillar part connecting the second roof panel part and the second rocker panel part, the second A-pillar part including a fifth tie rail directly attached to the second tie rail at a second location; and
(d) a second quarter panel part connecting the second roof panel part and the second rocker panel part, the second quarter panel part including a sixth tie rail directly attached to the third tie rail at a third location.

16. The automotive vehicular structure of Claim 15, wherein the first tie rail and the fourth tie rail overlap in an area supporting a windshield.

17. The automotive vehicular structure of Claim 15, wherein the first tie rail and the fourth tie rail overlap in an area sealing a windshield.

18. The automotive vehicular structure of claim 14, wherein first roof panel part defines portions of a roof opening above a passenger compartment.

19. The automotive vehicular structure of claim 14, wherein at least one of the first body side outer panel and the second body side outer panel are entirely composed of materials free of carbon fiber.

20. An automotive vehicular structure, comprising:
a composite floor pan structure extending along a length between an A-pillar and a B-pillar; and
a composite outer body structure coupled to the floor pan to create a first closed multi-sided rocker section along the length.

21. The automotive vehicular structure of claim 20, further comprising a composite closeout panel structure coupled to the floor pan and the outer body structure to create a second closed multi-sided rocker section surrounding the first closed multi-sided rocker section.

22. The automotive vehicular structure of claim 20, wherein the floor pan structure and the outer body structure are joined along the length by a structural adhesive.

23. The automotive vehicular structure of claim 20, wherein the floor pan structure and the outer body structure are entirely composed of materials free of carbon fiber.

24. An automotive vehicular structure, comprising:
a composite underbody structure creating a first part of an A-pillar; and
a composite outer body structure directly attached to the underbody structure to create a closed multi-sided A-pillar section along a length.

25. The automotive vehicular structure of claim 24, wherein the underbody structure and the outer body structure are attached along the length by a structural adhesive.

26. The automotive vehicular structure of claim 24, wherein the underbody structure and the outer body structure are entirely composed of materials free of carbon fiber.

27. A floor pan structure for an automotive vehicle, comprising:
a composite floor;
a pair of sides integral to and extending from the floor as a single piece; and
a raised section extending from the floor between the sides as a single piece, the raised section providing a mounting surface adapted for attachment of a passenger seat.

28. The floor pan structure of claim 27, wherein the floor, the sides, and the raised section are entirely composed of materials free of carbon fiber.

29. An automotive vehicular structure, comprising:
a composite floor pan structure including side wall integral to the floor pan structure as a single piece; and
a composite frame structure directly attached to an outboard side of the side wall; and
a composite outer body structure directly attached to the frame structure opposite the floor pan to create a pillar having a closed multi-sided pillar cross-section.

30. The automotive vehicular structure of claim 29, wherein the floor pan structure, the frame structure, and the outer body structure are entirely composed of materials free of carbon fiber.

31. The automotive vehicular structure of claim 29, further comprising a structural adhesive directly attaching the outer body structure to the frame structure.

32. An automotive vehicular structure, comprising:
a composite floor pan structure including an outer side wall integral to the floor pan structure as a single piece;
a composite outer body structure directly attached to a first side of outer side wall to create a pillar having a first closed multi-sided pillar cross-section when viewed along the pillar; and
a composite frame structure directly attached to an opposite second side of the outer side wall to create a second closed multi-sided pillar cross-section contiguous with the first closed multi-sided pillar cross-section.

33. The automotive vehicular structure of claim 32, wherein the floor pan structure, the outer body structure, and the frame structure are entirely composed of materials free of carbon fiber.

34. An automotive vehicular structure, comprising:
an exterior side panel including an A-pillar section, a B-pillar section, a rocker section, a roof rail section and a quarter panel section;
the sections all being a single piece, glass or polymeric fiber reinforced, composite part which is free of carbon fiber; and
the panel having an integral high gloss Class-A exterior surface finish.

35. The automotive vehicular structure of claim 34, further comprising a composite cross car member attached to the side panel, and an electric-drive engine compartment attached to at least the cross car member.

36. The automotive vehicular structure of claim 34, wherein the side panel includes a contiguous weatherstrip_mounting flange defining an internal door opening.

37. A method of assembling an automotive vehicle, the method comprising attaching a first exterior side panel to a second exterior side panel adjacent a vehicular centerline running in a fore-and-aft direction, each of the side panels including an internal passenger door opening at least partially located between A-pillar and B-pillar sections.

38. The method of claim 37, wherein the side panels are entirely made of painted composite materials free of carbon fiber.

39. The method of claim 37, further comprising directly attaching a composite floor panel to the side panels without any metallic body structure used to stiffen the vehicle under a passenger compartment defined by the side and floor panels.

40. The automotive vehicular structure of claim 20, wherein the first closed multi-sided rocker section connects one of a battery mounting surface and a suspension mounting surface of the floor pan structure to the outer body structure along a portion of the length.

41. The automotive vehicular structure of claim 25, wherein the composite structures include fiber reinforced resin and the outer body structure has a Class-A exterior surface.

42. The floor pan structure of claim 27, wherein the floor includes fiber reinforced resin and the floor acts as a structural member supporting a passenger compartment free of metallic frames.

43. The floor pan structure of claim 27, further comprising a battery compartment coupled to the floor, the battery compartment being accessible from below the floor.

44. The floor pan structure of claim 27, wherein the sides define parts of longitudinally extending closed multi-sided rocker sections.

45. The automotive vehicular structure of claim 29, further comprising a structural adhesive directly attaching the frame structure to the side wall of the floor pan structure.

46. The automotive vehicular structure of claim 29, wherein the pillar cross-section defines at least one of a windshield mounting flange portion and a door seal mounting flange portion.

47. The automotive vehicular structure of claim 29, wherein the pillar includes an integral high gloss Class-A exterior surface finish.

48. The automotive vehicular structure of claim 34, wherein the panel includes a door mounting surface.

49. The automotive vehicular structure of claim 34, wherein the panel includes portions of a windshield mounting flange.

50. The method of claim 37, wherein the side panels are composite parts including fiber reinforced resin.

51. An automotive vehicular apparatus, comprising:
a first exterior side panel; and
a second exterior side panel attached to the first exterior side panel adjacent a vehicular centerline running in a fore-and-aft direction, each of the side panels including an internal passenger door opening at least partially located between A-pillar and B-pillar sections.

52. The automotive vehicular apparatus of claim 51, wherein the side panels are painted composite parts including only composite materials free of carbon fiber.

53. The automotive vehicular apparatus of claim 51, further comprising a composite floor panel directly attached to the side panels without any metallic body structure used to stiffen the vehicle under a passenger compartment defined by the side and floor panels.

54. An automotive vehicular structure, the structure comprising:
(a) a composite floor pan having a longitudinal axis, the floor pan including:
a floor bottom extending along a substantially horizontal plane; and
side walls extending upwardly from opposite sides of the floor bottom; and
(b) a composite frame joined to the floor pan, the frame including:
a roof frame member;
elongated pillars extending from the roof frame member to the floor pan, the pillars being directly joined to the side walls of the floor pan;
(c) a composite first body side outer panel directly joined to a first one of the side walls, the first body side outer panel defining at least an entire first door opening; and
(d) a composite second body side outer panel directly joined to a second one of the side walls, the second body side outer panel defining at least an entire second door opening,
wherein, together the floor pan and the frame create contiguous composite sections connecting the first and second body side outer panels.

55. The automotive vehicular structure of claim 54, further comprising an elongated beam for supporting an instrument panel, the beam having ends attached to the pillars.

56. The automotive vehicular structure of claim 55, further comprising bolted connections attaching the ends of the beam to the pillars.

57. The automotive vehicular structure of claim 54, further comprising door attachment hardware mounted on at least one of the first and second body side outer panels.
